(19) United States
(12) Patent Application Publication
(10) Pub. No.: US 2012/0096751 A1
(43) Pub. Date: Apr. 26, 2012

(54) Integrated multilayered application label

(76) Inventors: Thomas D. Ray, III, Birmingham, AL (US); Robert J. Alden, Birmingham, AL (US); Tommy W. Gill, Moody, AL (US); James J. Carides, Tampa, FL (US)

(21) Appl. No.: 12/926,057

(22) Filed: Oct. 22, 2010

(51) Int. Cl. G09F 3/10

(52) U.S. Cl. 40/638

(57) ABSTRACT

A multilayered application label includes a front layer which has primary and supplemental information printed thereon and respectively viewable from opposite sides thereof, and a rear layer which has extended information printed thereon. The front layer includes a clear base film with a clear protective overcoat over a front surface and a clear adhesive on a rear surface. The supplemental information can be reverse printed on the front surface of the clear base film and the primary information can be printed on a white coating covering the supplemental information. The rear layer includes a white base film with a transparent release layer thereover and an adhesive undercoat. The extended information can be printed on the front surface of the rear layer and is exposed with peeling back of the front layer.

### BACKGROUND OF THE INVENTION

1. Field of the Invention

The invention relates to labels which can be applied to products or packaging to convey information regarding the products to purchasers or sellers (e.g., UPC codes for sale purposes).

2. The Prior Art

Labels applied to products or product packaging are well known and usually display relevant information on their front (exposed) sides, and in some cases also on their rear (hidden) sides and readable upon partial peeling of the label away from the products or packaging. With labels that are applied to small or unusually shaped products, it is often necessary to provide additional areas other than their front and rear sides for the desired information. In this regard, labels are known which include folded segments beneath the top (exposed) segment, as are labels which include pouches for containing booklets of information. However, these types of labels often exhibit edge stress, resulting in their edges undesirably lifting away from the product, and may require specialized manufacturing equipment and manufacturing processes that have low yields due to the complexity of the construction of the label.

The object of the present invention is to provide an integrated multilayered application label which is capable of supplying extended information, yet does not degrade the shape of the product or packaging on which it is attached, and which does not require specialized manufacturing equipment.

### SUMMARY OF INVENTION

According to this invention, the integrated multilayered application label includes a front layer and a separate rear layer adhered to the rear side of the front layer but separable therefrom, the front layer displaying primary information on its front side and supplemental information on its rear side, and the rear layer displaying extended information viewable from its front side when the front layer is peeled away.

The rear layer is formed of a white base film which has the extended information printed on its front side, a clear release coating covering its front side, and an adhesive coating covering its rear side. The adhesive coating will firmly attach the rear layer to the product on which it is placed.

The front layer includes a clear base film which has both primary and supplemental information printed thereon, a clear protective coating over its front side and clear adhesive on its rear side. The primary information is observable through the clear protective coating and the supplemental information is observable through the clear adhesive on the rear side of the clear base film.

When the integrated multilayered application label has been applied to a product, the primary information will be readily visible. The front layer can be peeled away from the product so as to expose the supplemental information observable from its rear side, and also peeled away from the rear layer due to the release coating thereon. This will expose the extended information observable from the front side of the rear layer. The rear layer will remain attached to the product.

The invention will be better understood by reference to the attached drawings, taken in conjunction with the following discussion.

### BRIEF DESCRIPTION OF THE DRAWINGS

FIG. 1 is a front view of an integrated multilayered application label according to a preferred embodiment of the present invention.

FIG. 2 is a rear view thereof,

FIG. 3 is a front view thereof but wherein the front layer has been partially peeled away from the rear layer,

FIG. 4 illustrates the construction of both the front and rear layers of the label, as well as the liner strip on which the labels are produced, and

FIG. 5 schematically depicts the assembly equipment used to produce a continuous series of the inventive labels.

### DETAILED DESCRIPTION OF THE PREFERRED EMBODIMENT

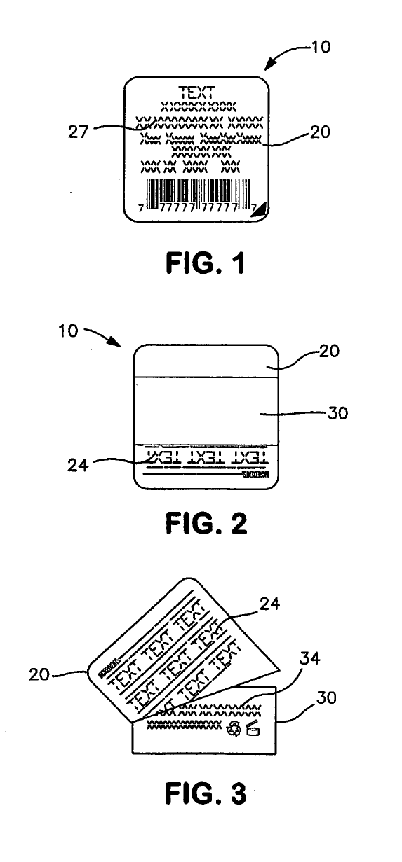

An integrated multilayered application label 10 according to a preferred embodiment of the present invention is shown in FIGS. 1-3. It includes a front layer 20 and a rear layer 30. The rear layer 30 is smaller in size than the front layer 20 and is adhered to the middle of the rear side of the front layer.

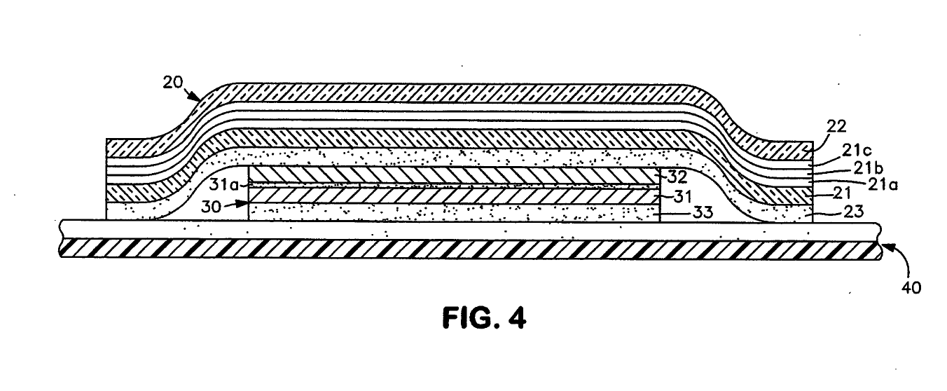

As best seen in FIG. 4, the front layer 20 includes a clear base film 21, a transparent protective coating (e.g., varnish overcoat) 22 that covers the front surface of the base film 21, and a clear adhesive 23 located on the rear surface of the film sublayer 21. The adhesive 23 can be continuous or discontinuously applied (patterned) and can be omitted at a corner of the front layer intended to be manually gripped for peeling of the front layer away from the object on which it is placed. The front surface of the base film 21 has a first printing layer 21a of information 24 thereon that can be read through both the base film 21 and adhesive 23, two layers 21b of white ink thereover, and a second printing layer 21c of information 27 on the white ink coats that can be read through the clear protective overcoat 22. The information 27 is clearly seen in FIG. 1 and the information 24 is clearly seen in FIG. 3.

The rear layer 30 includes a white base film 31, a clear release overcoat 32 covering its front surface, and an adhesive undercoat 33 covering its rear surface. The white base film 31 includes a printing layer 31a of information 34 on Its front surface which is readable through the release overcoat 32 when the front layer 20 has been peeled back (see FIG. 3).

The information 27 can be considered to be primary information to be provided by the multilayered label, the information 24 can be considered to be supplemental information, and the information 34 can be considered to be extended information. The adhesive undercoat 33 will retain the rear layer 30 on the product to which the label is adhered when the front layer 20 is manually peeled away from the product due to the release overcoat 32.

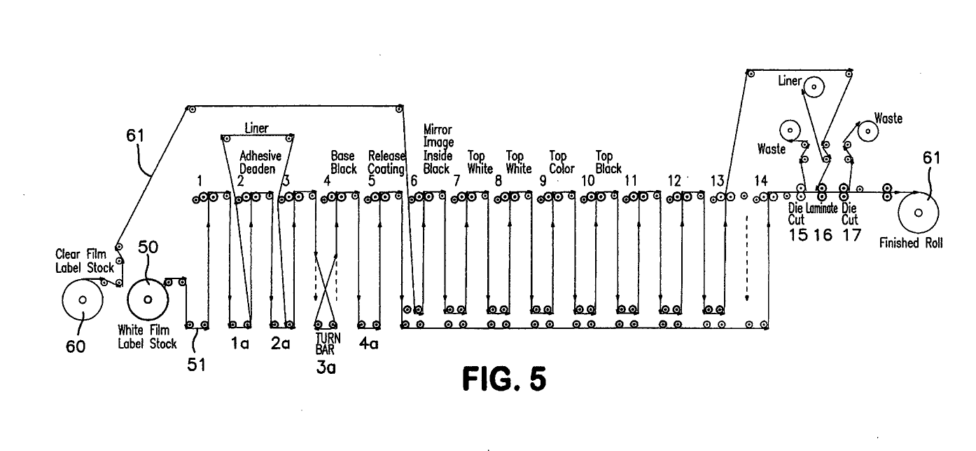

The integrated multilayered labels of the invention can be produced in a production assembly illustrated in FIG. 5. White film label stock 51 which is used to provide the rear layers 30 on each of the inventive multilayered labels, is unwound from roll 50 and passed through roller station 1 (white face sheet facing down) and to roller station 1a, where the liner is separated from the white face sheet. The white face sheet is fed to roller station 2 where portions of the adhesive layer on the back of the face sheet are deadened. The face sheet is thereafter fed to roller station 2a where the liner is reunited with the face sheet, and the combined face sheet and liner are passed to roller stations 3 and 3a (where the orientation of the face sheet and liner are reversed), and on to printing station 4 wherein the face sheet is series printed (with the desired extended information 34, and then to roller stations 4a and coating station 5 where a release coating (silicone) 32 is applied over the printed face sheet. The combined face sheet (with printing) with release overcoat and supporting liner are then fed to roller station 14 and die cut station 15 where a series of spaced face sheet portions with identical printing thereon are provided on the liner. These face sheet portions will form the rear layers 30 of the integrated multilayered label.

Concurrently with the foregoing, clear film label stock 61, which is used to provide the front layer 20 of each of the inventive integrated multilayered labels, is unwound from roil 60 and fed to a printing station 6 where the desired supplemental information 24 is series printed (mirror image) on the clear base film, then to printing stations 7 and 8 where coatings of white ink are coated over the printed supplemental information, then to printing stations 9 and 10 where the desired primary information 27 is printed on top of the white ink coatings, then to roller stations 11, 12 and 13, and then to laminate station 16 where the clear base film (with primary and supplemental information printed thereon, and with the liner removed) is applied to the liner 40 carrying the face sheet portions 30 so that the locations on the clear film are in register with the face sheet portions 30, and the combined films are passed through a die cut station 17 where the extraneous areas of the clear film are cut way, thus leaving multilayered labels 10 on the liner of the white film label stock, which is wound up as finished roll 61.

Although a preferred embodiment of an integrated multilayered label according to this invention, as well as apparatus for producing the labels, has been described, modifications therein can be made and still fall with the scope of the appended claims.

We claim:

1. An integrated multilayered application label which provides separate areas for primary information, supplemental information and extended information, said multilayered label comprising:
a front layer which includes a clear base film, a clear protective overcoat covering a front surface of the clear base film, and a clear adhesive on a rear surface of the clear base film, said clear base film including printing thereon which provides said primary information which can be seen through said transparent protective overcoat and said supplemental information which can be seen through said transparent adhesive, and
a rear layer removably positioned against the adhesive of the front layer, said rear layer including a white base film, a transparent release overcoat, and an adhesive undercoat, said white base film including printing on the front surface thereof which provides said extended information which can be seen through said clear release overcoat when the front and rear layers are separated.

2. The integrated multilayered application label according to claim 1, wherein said supplementary information is printed on said front surface of said clear base film, wherein a white coating layer covers said supplemental information, and said primary information is printed on said white coating layer.

3. The integrated multilayered application label according to claim 2, wherein said supplementary information is reverse printed on said clear base film.

4. The integrated multilayered application label according to claim 1, wherein the clear adhesive forms a continuous layer on the rear surface of the clear base film.

5. The integrated multilayered application label according to claim 1, wherein the clear adhesive only partially covers the rear surface of the clear base film.

6. The integrated multilayered application label according to claim 5, wherein said clear adhesive is placed on said clear base film in a pattern.
